(19) United States
(12) Patent Application Publication
(10) Pub. No.: US 2007/0169298 A1
(43) Pub. Date: Jul. 26, 2007

(54) Caulk spreading and smoothing tool

(76) Inventor: Ray Charles Marshall III, Spanaway, WA (US)

Correspondence Address: JAMES RAY & ASSOCIATES, 2640 Pitcairn Road, Monroeville, PA, 15146, US

(21) Appl. No.: 11/649,091

(22) Filed: Jan. 2, 2007

Related U.S. Application Data
(60) Provisional application No. 60/756,425, filed on Jan. 4, 2006.

(51) Int. Cl. B05C 17/10

(52) U.S. Cl. 15/235.7; 15/245.1

(57) ABSTRACT

A hand-held tool for shaping and smoothing rough beads of highly viscous liquids or pastes, such as caulking compounds or putty, and composed of a long thin, essentially rigid core with a predetermined length to width ratio, and further having a flexible outer covering, tightly encasing the rigid core over all surfaces except for the extreme ends, with the outer covering made from either soft rubber, flexible foam, or transparent flexible plastic. The working end of the tool can be cut to a desired shape and eventually trimmed off for easy cleanup.

### CROSS REFERENCE TO RELATED APPLICATION

This patent application is related to and claims priority from U.S. Provisional Patent Application Ser. No. 60/756,425 filed Jan. 4, 2006.

### FIELD OF THE INVENTION

The present invention relates, in general, to devices for finishing the application of viscous liquid caulk, grout or putty in crevices and around windows and, more particularly, this invention relates to caulk or putty finishing devices that can be disposable and are readily trimmed to a desired shape or angle.

### BACKGROUND OF THE INVENTION

Prior to the conception and development of the present invention, those applying caulking or putty to fill in cracks or gaps around windows and the like during home construction, remodeling, or repair would smooth out a fresh, rough bead of caulk using their finger or a putty knife. Particularly for crevices where two planar surfaces form about a 90-degree angle, a putty knife is typically too wide and awkward to use for this purpose and does not provide a uniformly smooth bead, and also allows excess caulk to remain a short distance from the finished bead. Use of one's finger poses risk of injury and creates cleanup and exposure problems.

Various hand held tools have been proposed or marketed over the years to facilitate the smoothing and shaping of a rough bead of caulk. For example, U.S. Pat. No. 3,846,060 describes a tool shaped much like a person's finger that one drags along a rough bead of caulk to shape it and smooth it.

In U.S. Pat. No. 4,586,890, a caulk bead tool is disclosed for contouring fresh caulk to a quarter-round bead, and then the opposite end is used to wipe away excess caulk pushed away from the finished bead. A tool is disclosed in U.S. Pat. No. 5,075,916 for shaping and smoothing a fresh bead of caulk to one of three sizes in shapes such as triangular prism or concave beads. U.S. Pat. No. 5,018,956 discloses a tool for finishing caulk or glazing compound that has as a primary feature the ability to guide excess compound away from the finished bead so as to better enable cleaning off that material without disturbing the main bead. In all four of the patents above, there is a need to go back and clean off the ribbons or specks of excess caulk that got pushed away from the finished bead.

Others have proposed designs touted to prevent the material from escaping beyond the working edges of the tool so as to obviate the need to go back and clean off the overflow caulk. For example, U.S. Pat. No. 4,211,501 teaches a spreading tool design that incorporates V-shaped elastomeric tips on the ends of an elongated rectangular strip. U.S. Pat. No. 6,219,878 describes an arrow-shaped tool with a rubber-like tip that contains all the excess caulking material and pushes it ahead of the tool to the end of the bead. U.S. Pat. No. 6,880,198 discloses a tool with a rigid, multi-faceted working end with surfaces at various angles to one another, and with the side edges having integral, flexible flaps.

There are some noteworthy shortcomings for all of the aforementioned tools. One is that they all address only filling in gaps between two surfaces at essentially a 90-degree angle to each other and would be much less effective for finishing caulk in gaps between surfaces at about a 180 or 270-degree angle to one another. Also, all provide only one to three fixed shapes or sizes for the finished beads of caulk or putty. In addition, none address the matter of cleaning up residual material stuck to the tool after use, especially if set aside for several minutes or longer on a hot day thus allowing the material to harden on the working end of the tool.

### SUMMARY OF THE INVENTION

The present invention provides a solution to the shortcomings of the prior art noted above. A hand-held tool for shaping and smoothing rough beads of highly viscous liquids or pastes, such as caulking compounds, made of a long thin, rectangular, and substantially rigid core with a length to width ratio of at least four, and a flexible outer covering, tightly encasing the rigid core over all surfaces except for the extreme ends, and composed of either soft rubber, flexible foam, or flexible plastic. The working end of the tool can be trimmed to desired shapes and the inner core can be printed with a logo and instructions visible through a transparent outer covering.

### OBJECTS OF THE INVENTION

It is, therefore, one of the primary objects of the present invention to provide a simple, effective, customizable, yet inexpensive tool for shaping and smoothing freshly applied caulk to an attractive appearance.

Another object of the present invention is to provide an inexpensive caulk finishing tool with potential for partial or complete disposal after use, thus avoiding messy, time-consuming cleanup.

Still another object of the present invention is to provide a caulking tool that is readily shaped by trimming with a saw or shears to any of several contours or angles.

Yet another object of the present invention is to provide a tool that can easily provide built-in instructions or advertising without interfering with the operation of the device.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is an overview of the caulk spreading tool suitable as is for finishing caulk along a crevice between adjacent boards in the same plane, and also how printing can be added on either the inner core or the outer covering,

FIG. 2 illustrates how the device can be cut at an angle for shaping a caulk bead to a triangular prism shape.

FIG. 3 depicts how a notch can be cut in the tool for filling gaps between surfaces at 270 degrees to one another.

FIG. 4 illustrates the use of the tool in finishing a bead of freshly laid caulk.

### DESCRIPTION OF A PRESENTLY PREFERRED EMBODIMENT OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

Referring initially to FIG. 1, the caulk finishing tool 10 is shown in the as-made and sold form with the long, thin rectangular rigid core 12, upon which instructions and the trademark name 14 can be printed or painted. The flexible, transparent outer covering 16 is shown encasing the rigid core 12, with rounded edges 18. It can be used in this form for smoothing caulk along seams between adjacent boards in the same plane, or over recessed nail heads.

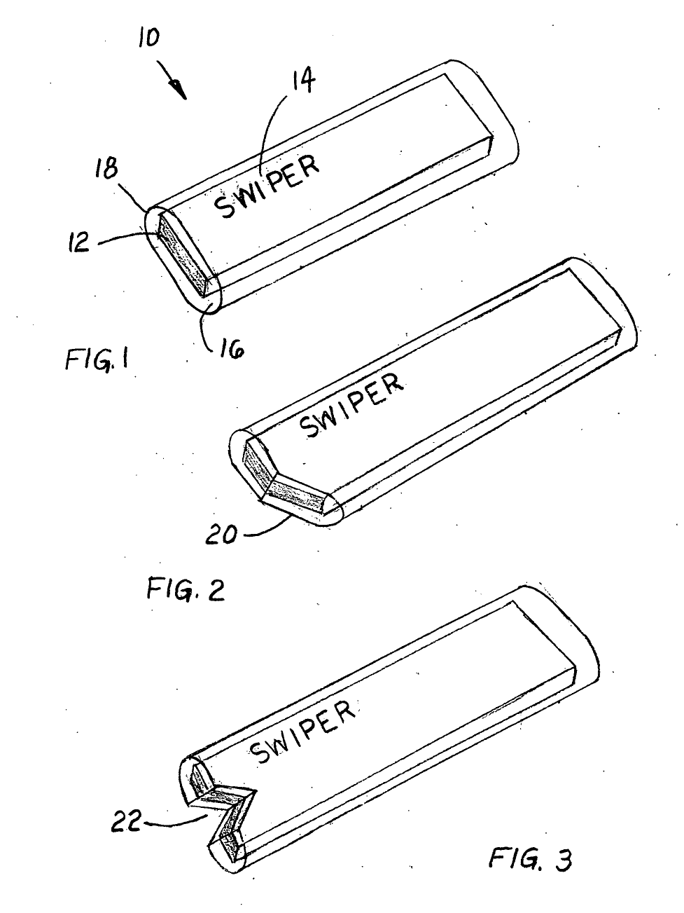

FIG. 2 depicts how the working end of the tool can be cut at an angle 20 so that the finished bead can be shaped to a triangular prism as the tool is pulled along the fresh caulk bead. The cut can be done with a saw, or if both the core and outer material are thin and soft enough, scissors or shears. Similarly, the messy working end of the tool can be trimmed off and discarded when a segment of work is completed, thus avoiding a messy cleanup, especially if the caulk is partially dried on the working end.

In FIG. 3, it is shown how other shapes can be cut into the working end of the tool, such as a notch 22 for helping to finish caulk laid into a gap between surfaces at an outer corner.

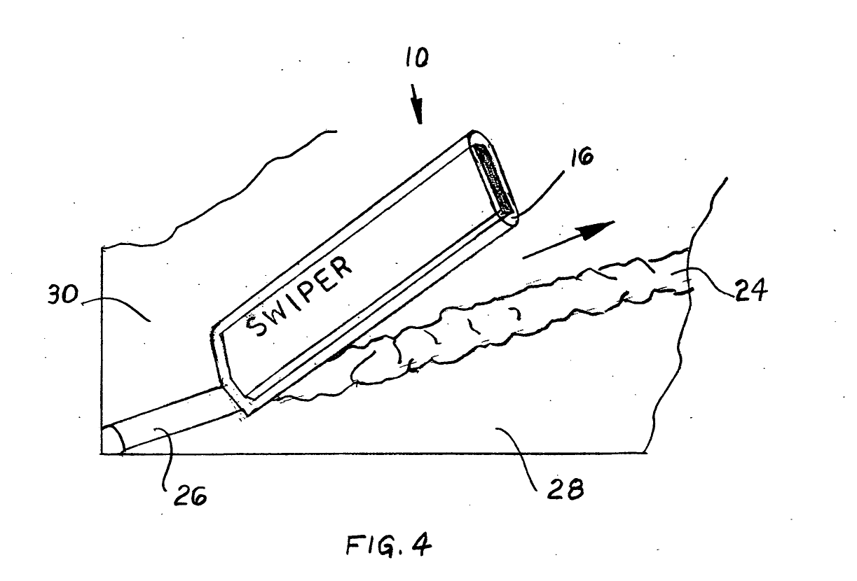

FIG. 4 illustrates the use of the tool 10 in smoothing a bead of caulk by dragging it along a fresh, rough bead of caulk 24, thereby pushing the caulk deeper into the crevice and leaving behind it a finished bead 26 of the desired shape between perpendicular surfaces 28 and 30. The flexible outer portion 16 of the tool helps to create a seal along the surfaces it contacts thereby minimizing any extraneous material being left behind necessitating a subsequent cleanup.

In actual use of the present invention, it has been found to be advantageous for the outer covering to be made from an opaque, three-eights inch thick flexible foam much like what is used for pipe insulation. The printed trade name and instructions can then be printed on a paper label glued to one flat side of the outer foam covering.

While a presently preferred embodiment of the invention has been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A hand-held tool for shaping and smoothing rough beads of at least one of highly viscous liquids and pastes, comprising:
a) a long, thin, generally rectangular and substantially rigid core with each of a first predetermined length, and a first predetermined width, and a first predetermined thickness, and a first predetermined material; and
b) a generally flexible outer covering formed from a second predetermined material with a second predetermined thickness, and encasing said substantially rigid core over substantially all surfaces.

2. The tool, according to claim 1, wherein said first predetermined length of said substantially rigid core is between about six and twenty inches.

3. The tool, according to claim 1, wherein said first predetermined thickness of said substantially rigid core is between about one-sixteenth and one-half inch thick.

4. The tool, according to claim 1, wherein said first predetermined width of said substantially rigid core is between about one inch and four inches.

5. The tool, according to claim 1, wherein said second predetermined thickness of said flexible outer covering is between about one-sixteenth and one inch.

6. The tool, according to claim 1, wherein said second predetermined material of said flexible outer covering is one of soft rubber, flexible foam, and flexible plastic.

7. The tool, according to claim 1, wherein said second predetermined material of said flexible outer covering is transparent.

8. The tool, according to claim 1, wherein said first predetermined material of said substantially rigid core is one of opaque plastic and opaque polymeric foam.

9. The tool, according to claim 8, wherein at least one surface of said opaque plastic has been treated for acceptance of printing.

10. The tool, according to claim 1, wherein said first predetermined material of said substantially rigid core is wood.

11. The tool, according to claim 1, wherein said first predetermined thickness of said substantially rigid core is about 0.25 inch.

12. The tool, according to claim 1, wherein said first predetermined width of said substantially rigid core is about 1.75-inches.

13. The tool, according to claim 1, wherein said first predetermined length of said substantially rigid core is about 12 inches.

14. The tool, according to claim 1, wherein said second predetermined thickness of said flexible outer covering is three-eights inch.

15. The tool, according to claim 1, wherein said second predetermined material of said flexible outer covering is a flexible foam.

16. The tool, according to claim 7, wherein said predetermined material of said flexible outer covering is a plasticized polyvinylchloride.

17. The tool, according to claim 7, wherein a printed strip of paper is sandwiched between said substantially rigid core and said flexible outer covering.

18. The tool, according to claim 15, wherein instructions printed on paper are adhered to said flexible outer covering.
